(19) United States
(12) Patent Application Publication
(10) Pub. No.: US 2026/0035990 A1
(43) Pub. Date: Feb. 5, 2026

(54) DOORSTOP AND DOORSTOP FILLER PACKAGE

(71) Applicant: Xujun Huang, Shanghai (CN)

(72) Inventor: Xujun Huang, Shanghai (CN)

(21) Appl. No.: 19/076,787

(22) Filed: Mar. 11, 2025

Related U.S. Application Data
(62) Division of application No. 19/001,973, filed on Dec. 26, 2024, now abandoned.

(30) Foreign Application Priority Data
Aug. 1, 2024 (CN) 2024218559368

(51) Int. Cl. E06B 7/23

(52) U.S. Cl. CPC E06B 7/2316

(57) ABSTRACT

A doorstop includes, first and second filler rods, and a doorstop accommodating bag. First and second accommodating portions are arranged on two sides of the doorstop accommodating bag for accommodating the filler rods. A gap is provided between the first and second side accommodating portions to form a doorstop groove after the filler rods are loaded into the accommodating portions. The doorstop groove has a groove inner surface. A hook-and-loop fastener is arranged at a lower side edge of a door. The groove inner surface is made of a first material, detachably attached and secured to the hook-and-loop fastener to enable the groove inner surface to be attached and secured to the hook-and-loop fastener. A surface of a part of the doorstop accommodating bag other than the groove inner surface is made of a second material. The first material has a coefficient of friction greater than that of the second material. The doorstop is prevented from detaching in an installation state to cause jamming of the door.

### TECHNICAL FIELD

The disclosure relates to a doorstop and a doorstop filler package.

### BACKGROUND

In order to promote air circulation and avoid moisture, gaps are provided between some household doors and floors or carpets. At low temperatures, it is necessary to install doorstops at lower side edges of the doors to block the gaps, thereby playing the roles of keeping out the wind, insulating heat and keeping warm.

### SUMMARY OF THE DISCLOSURE

After careful observation by the inventor, in order to enable a doorstop to be securely installed at a lower side edge of a door, a hook-and-loop fastener may be attached at the lower side edge of the door, and a material capable of being attached to the hook-and-loop fastener, such as a suede material, may be used in a place where the doorstop is in contact with the lower side edge of the door, so that the doorstop and the door are secured to each other. Since high friction of the suede material may result in high friction of the doorstop against a carpet, which hinders the opening and closing of the door, it is necessary to use a material with low friction in a place where the doorstop is in contact with the carpet, so as to reduce the friction of the doorstop against the carpet, thereby not hindering the opening and closing of the door. Also, the inventor has found that a doorstop filler material can be pressurized and sealed for easy carrying and storage of the doorstop.

Thus, according to a first aspect of the disclosure, a doorstop is provided, which is configured to be installed at a lower side edge of a door, the doorstop including: a first filler rod, a second filler rod and a doorstop accommodating bag, a first side accommodating portion and a second side accommodating portion being arranged on two sides of the doorstop accommodating bag respectively, and the first side accommodating portion and the second side accommodating portion being configured to accommodate the first filler rod and the second filler rod respectively; where a gap is provided between the first side accommodating portion and the second side accommodating portion to form a doorstop groove after the first filler rod and the second filler rod are loaded into the first side accommodating portion and the second side accommodating portion, the doorstop groove has a groove inner surface, and a hook-and-loop fastener is arranged at the lower side edge of the door; where the groove inner surface is made of a first material, and the first material is detachably attached and secured to the hook-and-loop fastener to enable the groove inner surface to be attached and secured to the hook-and-loop fastener, thereby installing the doorstop at the lower side edge of the door; and a surface of a part of the doorstop accommodating bag other than the groove inner surface is made of a second material, and the first material has a coefficient of friction greater than a coefficient of friction of the second material.

According to the first aspect of the disclosure, the first side accommodating portion is provided with a first side accommodating cavity, and the second side accommodating portion is provided with a second side accommodating cavity; and the first filler rod is accommodated inside the first side accommodating cavity, and the second filler rod is accommodated inside the second side accommodating cavity.

According to the first aspect of the disclosure, the first side accommodating portion is provided with a first accommodating cavity opening, and the second side accommodating portion is provided with a second accommodating cavity opening.

According to the first aspect of the disclosure, the doorstop accommodating bag is provided with a flexible sealing cover at an end where the first accommodating cavity opening and the second accommodating cavity opening are formed, and the sealing cover is provided with a hook-and-loop fastener; and the sealing cover is able to cover the first accommodating cavity opening and the second accommodating cavity opening when the sealing cover is bent toward the groove inner surface, thereby enclosing the first filler rod and the second filler rod inside the first side accommodating cavity and the second side accommodating cavity respectively.

According to the first aspect of the disclosure, the first material is a suede material, and the second material is a glossy material.

According to the first aspect of the disclosure, the first filler rod and the second filler rod are made of a compressible material.

According to a second aspect of the disclosure, a doorstop filler package is provided, including: a packaging bag and at least one filler rod, the packaging bag being made of a flexible material and provided with a closed packaging bag chamber, and the at least one filler rod being accommodated in the packaging bag chamber; where the at least one filler rod is compressed into a flattened shape and accommodated inside the packaging bag chamber by means of vacuum sealing.

According to the second aspect of the disclosure, the at least one filler rod is made of a compressible material.

According to the second aspect of the disclosure, the packaging bag is made of a composite material.

According to the second aspect of the disclosure, the at least one filler rod has a diameter of 3 cm to 7 cm in an uncompressed state, and the at least one filler rod has a thickness of 5 mm when sealed in a plastic packaging bag by means of vacuum pressurizing.

According to the second aspect of the disclosure, the at least one filler rod is foldable in a length direction when sealed in a plastic packaging bag by means of vacuum pressurizing; and the doorstop filler package has a free end portion, and in a folded state, the doorstop filler package is stably kept in the folded state by attaching the free end portion to exterior of the doorstop filler package.

According to the second aspect of the disclosure, the at least one filler rod includes two filler rods, and the two filler rods are sealed side by side in the packaging bag.

Some of the additional aspects and advantages of the disclosure will be set forth in the following description, and some will become apparent from the following description, or be learned by practice of the disclosure.

### BRIEF DESCRIPTION OF THE DRAWINGS

FIG. 1A is a perspective view of a doorstop and a door in an assembled state according to the disclosure;

FIG. 1B is a perspective view of a doorstop and a door in a disassembled state according to the disclosure;

FIG. 2A is a schematic diagram of a doorstop and a door in an initial installation state according to the disclosure;

FIG. 2B is a schematic diagram of a doorstop and a door in an intermediate installation state according to the disclosure;

FIG. 3A is a perspective view of a doorstop according to the disclosure from another perspective;

FIG. 3B is a perspective view of a doorstop according to the disclosure, with a sealing cover flipped open;

FIG. 3C is an exploded view of a doorstop according to the disclosure;

FIG. 3D is a perspective view of a doorstop enclosure of FIGS. 3A-3C when not loaded with a doorstop filler;

FIG. 4A is a schematic diagram of a sealed package of a doorstop filler;

FIG. 4B is a schematic diagram of another embodiment of the sealed package; and

FIG. 4C is a schematic diagram of the folded sealed package of a doorstop filler.

### DETAILED DESCRIPTION OF EMBODIMENTS

Various specific embodiments of the disclosure will be described below with reference to the accompanying drawings which constitute part of the disclosure, but the embodiments would not limit the scope of the disclosure. It should be understood that although the terms such as “upper”, “lower”, “left”, “right”, “front”, “rear” and so on indicating directions are used in the disclosure to describe orientations of various illustrative structural parts and elements in the disclosure, the terms used herein are merely used for ease of description and are determined based on the illustrative orientation shown in the accompanying drawings. Since the embodiments disclosed in the disclosure can be arranged in different orientations, the terms indicating directions are merely illustrative and should not be considered as limitations.

The term “comprise/include” and derivatives thereof mean inclusion without limitation. Unless otherwise specified and limited, the terms “mount”, “couple” and “connect” should be understood broadly. For example, they may be mechanical, electrical or communicational connection, internal communication between two elements, or direct connection or indirect connection via an intermediate medium. For those of at least ordinary skill in the art, the specific meanings of the above terms can be understood according to specific cases. If possible, the same or similar reference numerals used in the disclosure refer to the same components.

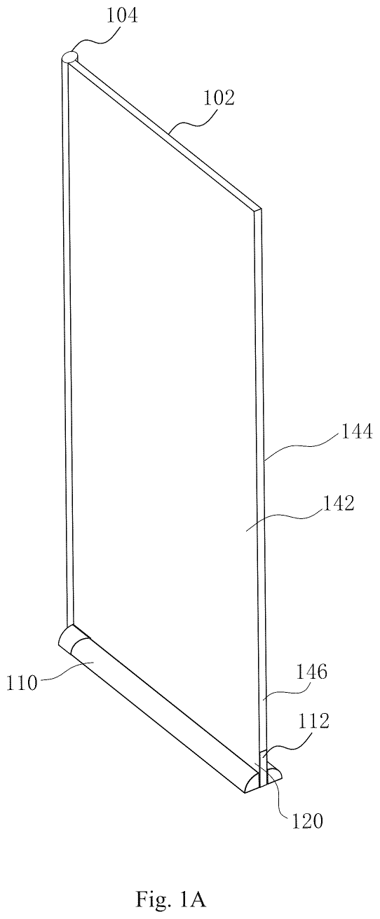

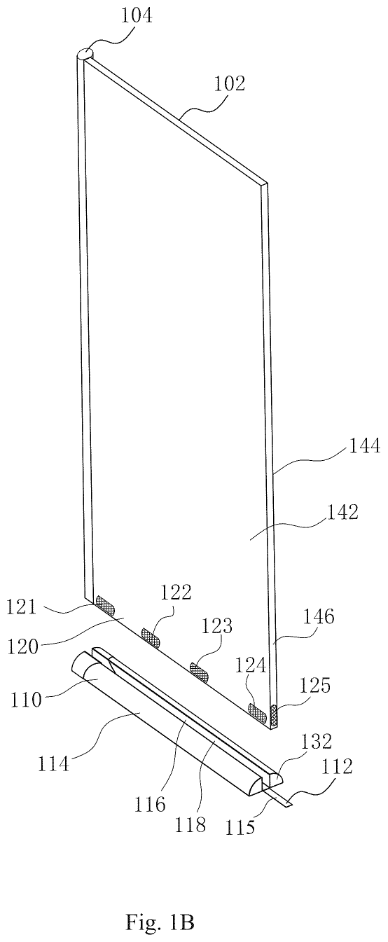

FIGS. 1A-1B illustrate perspective views of a doorstop and a door in an assembled state and a disassembled state respectively, where FIG. 1A is a perspective view of a doorstop and a door in an assembled state according to the disclosure; and FIG. 1B is a perspective view of a doorstop and a door in a disassembled state according to the disclosure.

As shown in FIGS. 1A-1B, a door 102 and a doorstop 110 are schematically illustrated, where the door 102 is provided with a pivoting shaft 104, and the door 102 is pivotable about the pivoting shaft 104 so as to realize opening and closing of the door 102. The doorstop 110 is made of a compressible soft material and installed at a lower side edge 120 of the door 102 for filling a gap between the door 102 and a carpet (not shown) so as to play the roles of keeping out the wind, insulating heat and keeping warm. The doorstop 110 is provided with a doorstop main body 114 and a doorstop groove 116, and the doorstop groove 116 runs through the doorstop main body 114 in a length direction of the doorstop main body 114 for wrapping and accommodating the lower side edge 120 of the door 102. The doorstop groove 116 has a groove inner surface 118, and the groove inner surface 118 is made of a suede material that may be attached to a hook-and-loop fastener. A flexible doorstop fixing strap 112 extends from the middle of a side surface 132 of the doorstop 110 in a width direction. The doorstop fixing strap 112 has a fixing strap attachment side 114 in an upper side direction of FIG. 1B, and the fixing strap attachment side 114 is also made of a suede material that may be attached to a hook-and-loop fastener.

Still as shown in FIGS. 1A-1B, hook-and-loop fasteners 121, 122, 123, 124, 125 (a hook-and-loop fastener on a back side 144 of the door 102 is not shown) are attached at lower side edges of a front side 142, a back side 144 and a side surface 146 that is opposite to the pivoting shaft 104 of the door 102. The hook-and-loop fasteners 121, 122, 123, 124, 125 have hook sides and attachment sides, the attachment sides are configured to be attached to the lower side edge of the door 102, and the hook sides of the hook-and-loop fasteners 121, 122, 123, 124 at the lower side edges of the front side 142 and the back side 144 of the door 102 are configured to be detachably attached and fixed to the groove inner surface 118 of the doorstop groove 116. The hook side of the hook-and-loop fastener 125 at the lower side edge of the side surface 146 of the door 102 is configured to be detachably attached and fixed to the fixing strap attachment side 114 of the doorstop fixing strap 112. In attachment, the doorstop fixing strap 112 may be bent toward the side surface 146 of the door 102 so as to be attached and fixed to the hook-and-loop fastener 125 on the side surface 146. The doorstop 110 and the door 102 may be securely attached and fixed together by attaching and fixing the above-mentioned hook-and-loop fasteners 121, 122, 123, 124, 125 to the suede materials at the corresponding positions of the doorstop 110, such that during movement (opening and closing) of the door 102, the doorstop 110 may not detach due to the friction of the carpet to cause jamming of the door. Parts of the doorstop 110 other than the doorstop groove 116 (a lower side and an outer sides of the doorstop main body 114) are made of a glossy material that is smoother than the suede material, for example, an oxford cloth material, such that a part of the doorstop 110 that is in contact with the carpet is made of the glossy material which has less friction than the suede material. In this way, the door 102 can still move and pivot easily on the carpet after the doorstop 110 is installed thereon, and it is also convenient to push the doorstop 110 from outside of the side surface 146 of the door 102 in an inward direction to receive the lower side edge of the door 102 during installation.

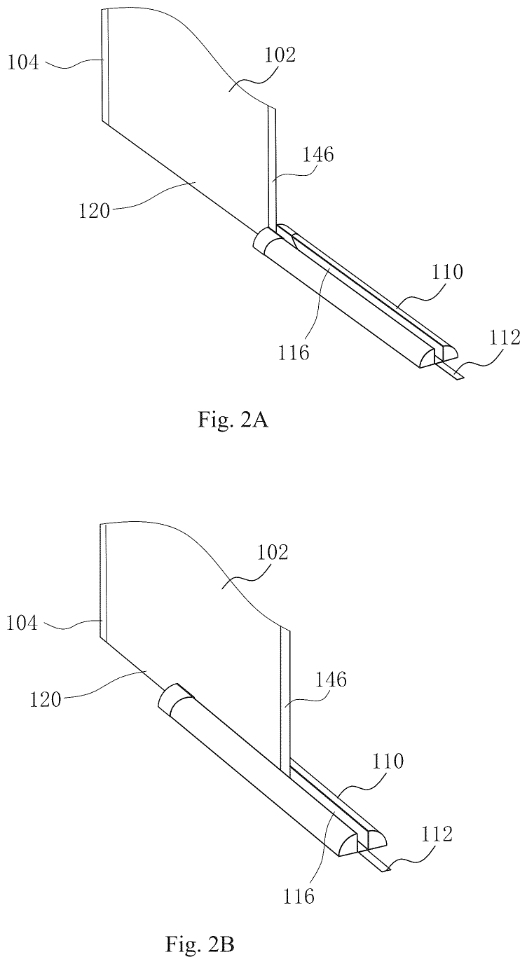

FIGS. 2A-2B illustrate a process of installation of the doorstop 110 and the door 102 (only the lower side of the door 102 is locally illustrated), where FIG. 2A is a schematic diagram of the doorstop and the door in an initial installation state according to the disclosure; and FIG. 2B is a schematic diagram of a doorstop and a door in an intermediate installation state according to the disclosure.

As shown in FIG. 2A, the doorstop 110 is installed from the outside of the side surface 146 of the door 102 that is opposite to the pivoting shaft 104. The lower side edge 120 of the door 102 is aligned with an end portion of the doorstop groove 116 of the doorstop 110, and the doorstop 110 is pushed from the outside of the side surface 146 toward the pivoting shaft 104 of the door 102. FIG. 2B illustrates a schematic diagram of the doorstop 110 when pushed to the middle of the lower side edge 120 of the door 102. When the doorstop 110 is pushed to completely wrap the lower side edge 120 of the door 102 (the position shown in FIG. 1A), since the doorstop 110 is made of the compressible soft material, an external force may be used to create a certain space between the doorstop groove 116 and the lower side edge 120 of the door 102, such that the hook-and-loop fasteners 121, 122, 123, 124, 125 are attached at positions of the lower side edge 120 of the door 102 which are in contact with the doorstop groove 116 and a position of the lower side edge of the side surface 146. Then, the suede material of the doorstop groove 116 is pressed against and attached to the hook-and-loop fasteners 121, 122, 123, 124, the doorstop fixing strap 112 is bent toward the side surface 146 of the door 102, and the doorstop fixing strap 112 is pressed against and attached to the hook-and-loop fastener 125 on the side surface 146, thereby completing attachment and installation of the doorstop 110 and the door 102. Since the hook-and-loop fasteners and the suede material in an attached state need to be separated from each other by a large external force, and the acting force for separation is greater than a friction detachment force brought by the carpet to the doorstop 110, the doorstop 110 may not detach from the door 102 due to the friction detachment force of the carpet in the process of opening and closing the door 102, but the doorstop 110 can be removed from the lower side edge 120 of the door 102 by applying a large external force.

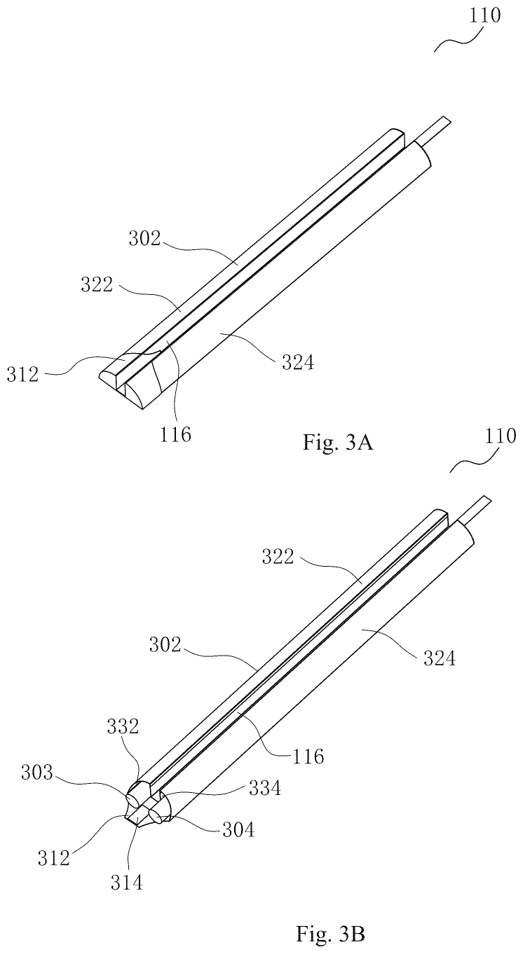

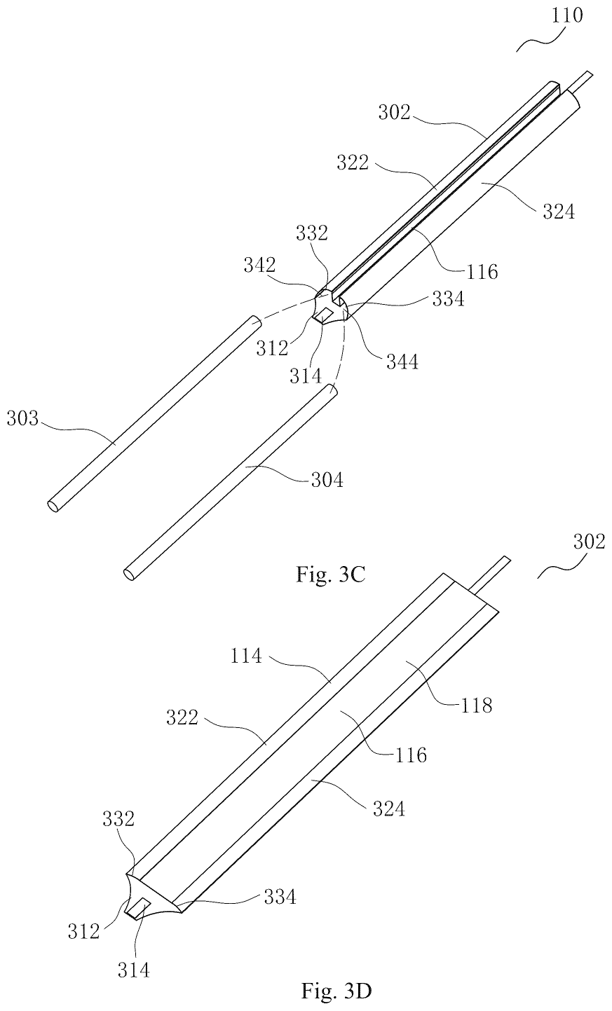

FIGS. 3A-3D illustrate specific structures and components of the doorstop according to the disclosure, where FIG. 3A is a perspective view of the doorstop according to the disclosure from another perspective; FIG. 3B is a perspective view of a doorstop according to the disclosure, with a sealing cover flipped open; FIG. 3C is an exploded view of the doorstop according to the disclosure; and FIG. 3D is a perspective view of a doorstop enclosure of FIGS. 3A-3C when not loaded with a doorstop filler.

As shown in FIGS. 3A-3C, the doorstop 110 is provided with a doorstop accommodating bag 302 and two doorstop fillers 303, 304, such as doorstop filler rods, accommodated inside the doorstop accommodating bag 302. In an embodiment of the disclosure, the doorstop accommodating bag 302 is made by stitching and splicing a suede material and an oxford cloth material, and the doorstop fillers 303, 304 are made of a compressible material, for example, a sponge material. As described above, a part of the doorstop accommodating bag 302 corresponding to the groove inner surface 118 is made of the suede material, and other parts of the doorstop accommodating bag 302 are made of the oxford cloth material. The doorstop accommodating bag 302 is provided with two filler accommodating portions 322, 324 arranged in a length direction, and the two filler accommodating portions 322, 324 are located on the left side and the right side of the doorstop accommodating bag 302 in the length direction respectively. Each of the two filler accommodating portions 322, 324 encloses a filler accommodating cavity 332, 334, the filler accommodating cavities 332, 334 are in a collapsed state when not loaded with the doorstop fillers 303, 304 (referring to FIG. 3D), and the filler accommodating cavities 332, 334 are propped up by the doorstop fillers 303, 304 after the filler accommodating cavities 332, 334 are loaded with the doorstop fillers 303, 304 (referring to FIG. 3B). After the first doorstop filler 303 and the second doorstop filler 304 are loaded into the first filler accommodating portion 322 and the second filler accommodating portion 324, a gap is provided between the first filler accommodating portion 322 and the second filler accommodating portion 324 to form the doorstop groove 116 described above.

As shown in FIG. 3B, one of the doorstop fillers 303, 304 may be accommodated inside one of the two filler accommodating cavities 332, 334. The two filler accommodating cavities 332, 334 are respectively provided with accommodating cavity openings 342, 344 (referring to FIG. 3C), and the other ends of the filler accommodating cavities 332, 334 opposite to the accommodating cavity openings 342, 344 are sealed. The doorstop fillers 303, 304 may be loaded into the filler accommodating cavities 332, 334 from the side of the accommodating cavity openings 342, 344, so as to prop up the doorstop accommodating bag 302. In a propped state of the doorstop accommodating bag 302, the doorstop groove 116 between the two filler accommodating portions 322, 324 may accommodate the lower side edge 120 of the door 102. When the doorstop 110 is installed at the lower side edge 120 of the door 102, the two filler accommodating cavities 332, 334 are respectively located on two sides (the front side 142 and the back side 144 of the door 102) of the lower side edge 120 of the door 102, and the doorstop 110 is in contact with the carpet, such that the gap between the lower side edge 120 of the door 102 and the carpet can be sealed. The two filler accommodating portions 322, 324 of the doorstop accommodating bag 302 and the two doorstop fillers 303, 304 jointly form the doorstop main body 114 of the doorstop 110.

Still as shown in FIGS. 3A-3C, the doorstop accommodating bag 302 is provided with a flexible sealing cover 312 on the side of the accommodating cavity openings 342, 344, the sealing cover 312 is formed by extending outward from the lower sides of the two filler accommodating cavities 332, 334, and the sealing cover 312 is attached with a hook-and-loop fastener 314. After the filler accommodating cavities 332, 334 are loaded with the doorstop fillers 303, 304, the sealing cover 312 may be bent upward from the position in FIG. 3B and toward the two filler accommodating portions 322, 324, so as to cover the accommodating cavity openings 342, 344, and the hook-and-loop fastener 314 of the sealing cover 312 and the suede material of the doorstop groove 116 are attached together, so as to enclose the doorstop fillers 303, 304 inside the filler accommodating cavities 332, 334.

As shown in FIG. 3D, the filler accommodating cavities 332, 334 of the doorstop accommodating bag 302, when not loaded with the doorstop fillers 303, 304, are in a collapsed state due to lack of propping from the doorstop fillers 303, 304, the doorstop accommodating bag 302 may be pressed into a flattened shape for easy storage and carrying. It can be seen that in a flattened state of the doorstop accommodating bag 302, except for the part, which is made of the suede material and corresponds to the groove inner surface 118 of the doorstop groove 116 in the propped state, other parts of the doorstop accommodating bag 302 are made of the oxford cloth material, and the part of the groove inner surface 118 is spliced together with the other parts by means of stitching.

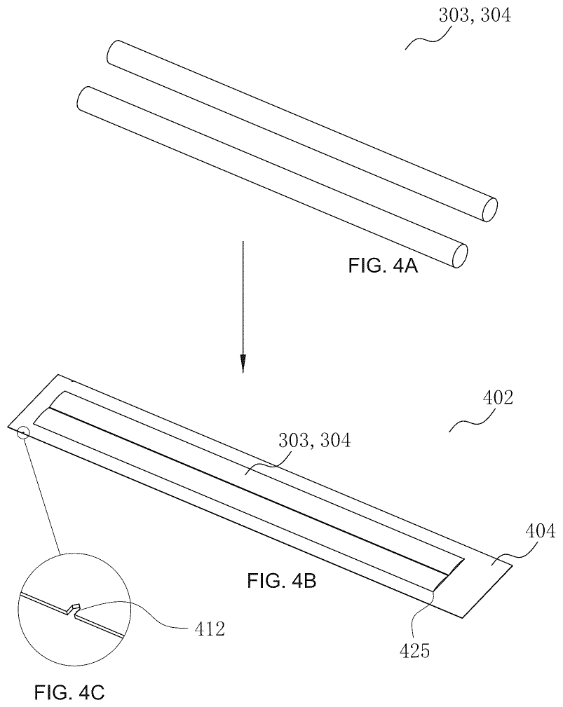

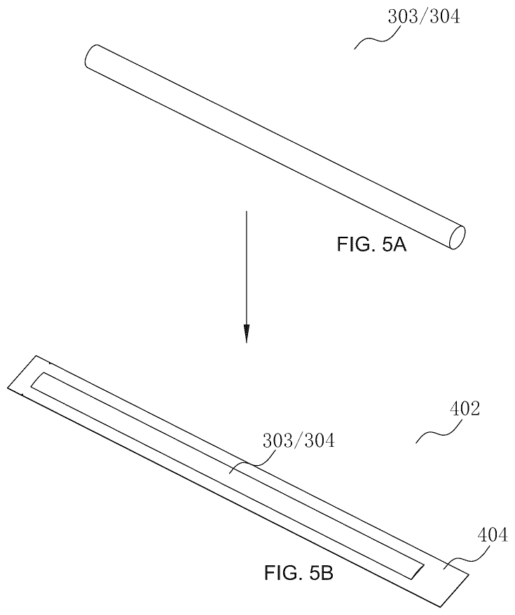

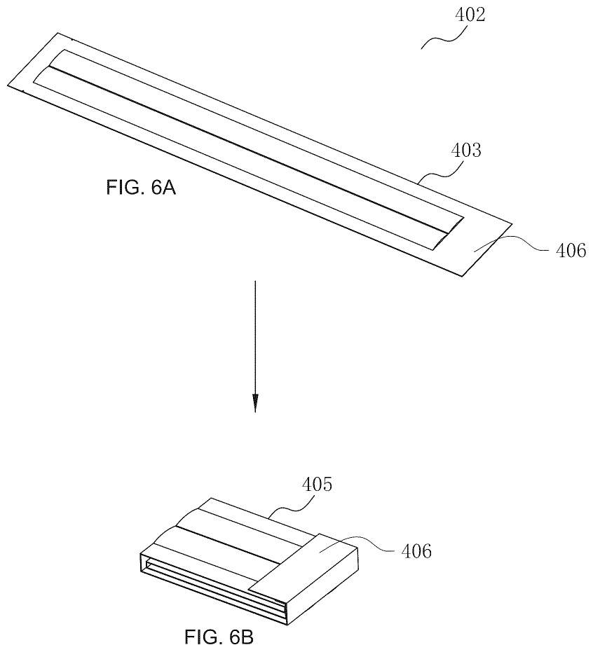

FIGS. 4A-4C illustrate a process of sealing and packaging the doorstop fillers, where FIG. 4A is a schematic diagram of a sealed package of the doorstop fillers; FIG. 4B is a schematic diagram of another embodiment of FIG. 4A; and FIG. 4C is a schematic diagram of the folded sealed package of a doorstop filler.

As shown in FIG. 4A, a flexible packaging bag 404 has a packaging bag chamber 425 that may be configured to accommodate the doorstop fillers 303, 304. By the process of vacuum compression, the set of two doorstop fillers 303, 304 that need to be filled may be flattened and then sealed side by side in the flexible packaging bag 404 by means of vacuum sealing, so as to form a sealed package 402 of the doorstop fillers 303,304. The doorstop filler has a diameter of 3 cm to 7 cm before compression. In an embodiment of the disclosure, each of the doorstop fillers 303, 304 has a diameter of 5 cm before compression, is in a flattened shape after compression by means of pressurizing, and has a thickness of only 5 mm after the doorstop filler 303,304 is compressed and then sealed in the flexible packaging bag 404. By compressing and vacuum-scaling the doorstop fillers 303, 304 in the flexible packaging bag 404, the overall size for package of the doorstop fillers 303,304 can be reduced for easy storage and carrying. In an embodiment of the disclosure, the flexible packaging bag 404 is made of a flexible composite material, for example, a nylon and polyethylene (PE) composite material, which has the advantages of good heat resistance and high sealing performance. When the doorstop fillers 303, 304 are sealed in the nylon and polyethylene (PE) composite packaging bag 404, the sealed bag can be prevented from air leakage to the greatest extent, thereby preventing a possible scaling failure, a possible increase in size of the sealed packaging bag and the like.

In addition, a tear 412 (as shown in an enlarged view A) is formed in the flexible packaging bag 404 near an end portion to facilitate opening of the flexible packaging bag 404 when the doorstop fillers 303, 304 are in use.

FIG. 4B is a schematic diagram of another embodiment of the sealed package.

As will be appreciated by those skilled in the art, in some other embodiments, it is also possible to seal and package only an individual doorstop filler 303/304, so as to form two sealed packages of the doorstop fillers respectively.

As shown in FIG. 4C, the sealed package of the doorstop filler has an unfolded state 403 (as shown in the upper section of FIG. 4B) and a folded state 405 (as shown in the lower section of FIG. 4B). Based on the unfolded state 403 of the sealed package of the doorstop filler, the sealed package 402 may be folded in a length direction, so as to form the folded state 405 of the sealed package 402 that is smaller in the length direction for further case of storage and carrying. In an embodiment of the disclosure, the folded state 405 of the sealed package is formed by means of folding twice. As will be appreciated by those skilled in the art, in some other embodiments, the folded state of the sealed package may be formed by one or more times of folding. The sealed package 402 of the doorstop filler has a free end portion 406. By applying an adhesive to the free end portion 406 when in the folded state 405 of the sealed package, the free end portion 406 is fixed at a specific position on the exterior of the sealed package 402 in the folded state, to stably keep the sealed package of the doorstop filler in the folded state 405, which prevents the doorstop filler in the folded state from rebounding to the unfolded state 403 due to the elasticity of the doorstop filler.

As will be appreciated by those skilled in the art, in some other embodiments, the two doorstop fillers may also be sealed and packaged separately to form two separate sealed packages of the doorstop fillers and the folded states of the two separate sealed packages of the doorstop fillers.

The objective of the disclosure is to solve, at least in part of the technical problems as referred to herein. The doorstop and the doorstop fillers according to the disclosure can achieve at least the following beneficial technical effects.

First, the doorstop according to the disclosure is designed by splicing the suede material and the oxford cloth material, such that the doorstop can be securely installed at the lower side edge of the door by attachment between the suede material and the hook-and-loop fasteners. In addition, the friction that the doorstop is subjected to in the process of opening and closing the door is reduced by the contact between the oxford cloth material and the carpet, so as to prevent the doorstop from detaching in the installation state and thus prevent jamming of the door.

Second, due to the low friction between the doorstop and the carpet, it is convenient to install the doorstop at the lower side edge of the door.

Third, according to the disclosure, the doorstop fillers are sealed and packaged by means of vacuum compression, and the sealed package is folded and packaged, such that the lengths and the volume of the doorstop fillers are reduced for easy storage, containing and carrying.

Fourth, according to the disclosure, the doorstop fillers are pressurized, sealed and packaged using the nylon and polyethylene (PE) composite material, such that the sealed package can be prevented from air leakage to the greatest extent in order to achieve a stable and reliable sealed package.

Although the disclosure is described in conjunction with the examples of embodiments outlined above, various alternatives, modifications, variations, improvements, and/or substantial equivalents that are known or currently available or to be anticipated before long may be obvious to those of at least ordinary skill in the art. In addition, the technical effects and/or technical problems described in the disclosure are illustrative rather than restrictive. Therefore, the disclosed description in the disclosure may be used for solving other technical problems and have other technical effects and/or can solve other technical problems. Accordingly, the examples of the embodiments of the disclosure as set forth above are intended to be illustrative rather than limiting. Various changes can be made without departing from the spirit or scope of the disclosure. Therefore, the disclosure is intended to include all known or earlier developed alternatives, modifications, variations, improvements and/or basic equivalents.

1-6. (canceled)

7. A doorstop filler package, comprising:
a packaging bag (404) formed from, a flexible material and having a closed packaging bag chamber (425) and a free end portion (406); and
at least one filler rod (303, 304), formed from a compressible material and accommodated in the packaging bag chamber (425),
the at least one filler rod (303, 304) being compressed into a flattened shape and vacuum sealed inside the packaging bag chamber (425) to form the doorstop filler package,
wherein the doorstop filler package with at least one filler rod (303, 304) positioned in the packaging bag and vacuum sealed therein, is folded in a lengthwise direction to a folded state, and
wherein the doorstop filler package (402) has a free end portion (406), and wherein the the doorstop filler package (402) is secured in the folded state by attaching the free end portion (406) to an exterior of the doorstop filler package (402).

8. (canceled)

9. The doorstop filler package of claim 7, wherein the packaging bag (404) is made of a composite material.

10. The doorstop filler package of claim 7, wherein the at least one filler rod (303, 304) has a diameter of about 1.18 inches to about 2.75 inches (3 cm to 7 cm) in an uncompressed state, and the at least one filler rod (303, 304) has a thickness of about .197 inches (5 mm) when vacuum sealed in the packaging bag.

11. (canceled)

12. The doorstop filler package of claim 7, wherein the at least one filler rod (303, 304) comprises two filler rods (303, 304), and the two filler rods (303, 304) are sealed side by side in the packaging bag (404).
